(19) United States
(12) Patent Application Publication
(10) Pub. No.: US 2009/0160811 A1
(43) Pub. Date: Jun. 25, 2009

(54) INFORMATION PROCESSING APPARATUS AND INPUT CONTROL METHOD

(75) Inventors: Hironori Motoe, Ome-shi (JP); Daisuke Hosokawa, Hamura-shi (JP); Tooru Mamata, Akiruno-shi (JP); Hideaki Andou, Ome-shi (JP); Masahiro Horioka, Ome-shi (JP); Kageyuki Iso, Akishima-shi (JP); Yoshinori Wakizaka, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/337,447

(22) Filed: Dec. 17, 2008

(30) Foreign Application Priority Data
Dec. 21, 2007 (JP) 2007-331141

(51) Int. Cl. G06F 3/041

(52) U.S. Cl. 345/173

(57) ABSTRACT

According to one embodiment, an information processing apparatus includes a case, a display device provided in the case, a plurality of touch switches configured to output an operation signal in accordance with the change of capacitance and arranged inside the case, two or more touch switches being arranged in the vicinity of each two adjacent sides of the display device along each side, a keyboard controller configured to receive a key code, and a touch switch controller configured to receive the operation signal of the plurality of touch switches, the touch switch controller outputting, to the keyboard controller, the key code which corresponds to simultaneous input operations of a plurality of keys allocated to the operation of a particular touch switch when the operation signal is input from the particular touch switch.

### CROSS-REFERENCE TO RELATED APPLICATIONS

This application is based upon and claims the benefit of priority from Japanese Patent Application No. 2007-331141, filed Dec. 21, 2007, the entire contents of which are incorporated herein by reference.

### BACKGROUND

1. Field

One embodiment of the invention relates to an information processing apparatus and an input control method with improved operability.

2. Description of the Related Art

At present, development is carried out for CPUs and chip sets of computers so called ultra-mobile personal computers (UMPCs) which are equipped with LCDs sized at about six inches and which have cases smaller than that of a traditional notebook computer and slightly larger than that of a personal digital assistant (PDA). An operating system installed in this UMPC is Windows® as in conventional notebook computers.

As the UMPC is small, key tops of a mounted keyboard are reduced in size, or some of the keys to be mounted are omitted, or no keyboard may be mounted. Therefore, key inputs used in the operation of Windows may not be easily performed, or key inputs may be impossible.

A terminal apparatus having command keys distributed on the periphery of a screen has been disclosed in Jpn. Pat. Appln. KOKAI Publication No. 6-208433.

In the method described above, a signal corresponding to a certain command is only output, and it is not possible to output a key code corresponding to simultaneous inputs on a plurality of keys.

Furthermore, the command keys arranged on the periphery of the screen have single functions, and are not suitable for the UMPC having as small a case as possible.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the appearance of an information processing apparatus according to a first embodiment;

FIG. 2 is an exemplary perspective view showing the appearance of the information processing apparatus according to the first embodiment;

FIG. 3 is an exemplary sectional view showing the positions where touch switches are arranged according to the first embodiment;

FIG. 4 is an exemplary diagram showing a condition where a display unit in FIG. 1 has been rotated and a display has been turned to a closed position;

FIG. 5 is an exemplary block diagram showing a system configuration of the information processing apparatus shown in FIG. 1;

FIG. 6 is an exemplary block diagram showing a configuration for reporting input operation on the touch switches to a system;

FIG. 7 is an exemplary diagram showing the procedure of processing concerning the operation of the touch switch in an EC/KBC shown in FIG. 5;

FIG. 8A and FIG. 8B are exemplary diagrams showing the procedure of a display enlarging method according to a second embodiment;

FIG. 9 is an exemplary diagram showing a display enlarged by the operation shown in FIG. 8A and FIG. 8B;

FIG. 10A and FIG. 10B are exemplary diagrams showing the procedure for returning the enlarged display to a normal display;

FIG. 11A and FIG. 11B are exemplary diagrams showing the procedure for changing to the enlarged display after the return from the enlarged display to the normal display;

FIG. 12 is an exemplary flowchart showing the procedure of processing for recognizing whether an operation provided to a particular switch is a button operation or a swipe operation, according to a third embodiment;

FIG. 13 is a diagram showing the state of an enlarged display according to a fourth embodiment;

FIG. 14 is an exemplary diagram showing how contents in an LCD are scrolled by a swipe operation according to the fourth embodiment;

FIG. 15 is an exemplary diagram showing a state changed into a zoom mode according to the fourth embodiment;

FIG. 16 is an exemplary diagram showing how a display in the LCD is scrolled by the swipe operation according to the fourth embodiment;

FIG. 17 is an exemplary block diagram showing a system configuration of an information processing apparatus according to a fifth embodiment;

FIG. 18 is an exemplary diagram showing a state changed into a zoom mode according to the fifth embodiment;

FIG. 19 is an exemplary diagram showing how a place to be enlarged in an LCD is touched by the finger, according to the fifth embodiment;

FIG. 20 is an exemplary diagram showing an enlarged display around the place touched in FIG. 19, according to the fifth embodiment;

FIG. 21 is an exemplary diagram showing how a zoom mode switch is operated to cancel the enlarged display, according to the fifth embodiment;

FIG. 22 is an exemplary diagram showing a state changed to a normal display by the operation shown in FIG. 21;

FIG. 23 is an exemplary diagram showing how a zoom mode switch is operated to perform an enlarged display, according to a sixth embodiment;

FIG. 24 is an exemplary diagram showing of the enlarged display performed by the operation in FIG. 23;

FIG. 25 is an exemplary diagram showing how the enlargement ratio is increased from the state shown in FIG. 23 by operating touch switches from an upper side to a lower side;

FIG. 26 is an exemplary diagram showing how the enlargement ratio is decreased from the state shown in FIG. 23 by operating the touch switches from the upper side to the lower side; and

FIG. 27 is an exemplary diagram showing how the enlarged display is cancelled and changed to a normal display.

### DETAILED DESCRIPTION

Various embodiments according to the invention will be described hereinafter with reference to the accompanying drawings. In general, according to one embodiment of the invention, an information processing apparatus includes a case, a display device provided in the case, a plurality of touch switches configured to output an operation signal in accordance with the change of capacitance and arranged inside the case, two or more touch switches being arranged in the vicinity of each two adjacent sides of the display device along each side, a keyboard controller configured to receive a key code, and a touch switch controller configured to receive the operation signal of the plurality of touch switches, the touch switch controller outputting, to the keyboard controller, the key code which corresponds to simultaneous input operations of a plurality of keys allocated to the operation of a particular touch switch when the operation signal is input from the particular touch switch.

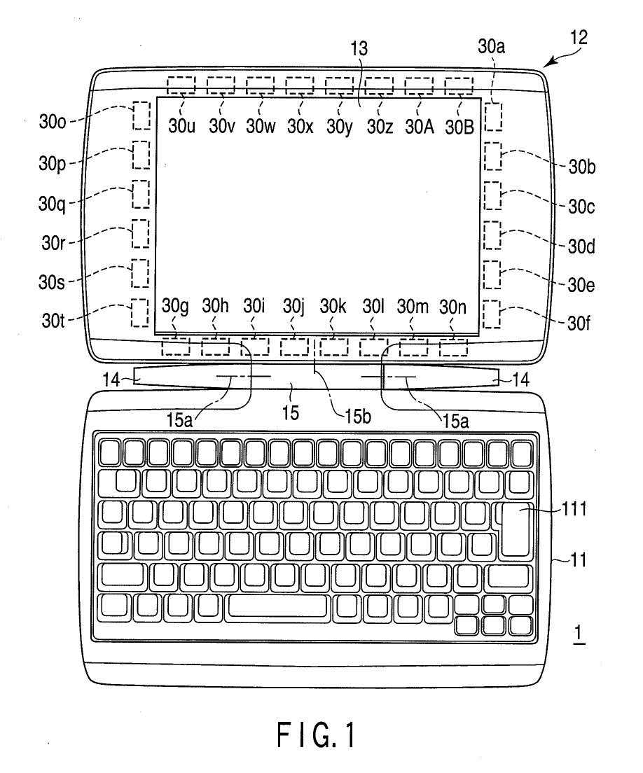

FIG. 1 is a diagram showing the schematic configuration of an ultra mobile personal computer (UMPC) as an information processing apparatus according to a first embodiment of the present invention.

A personal computer 1 comprises a computer main body 11 and a display unit 12. A liquid crystal display (LCD) 13 which is a display panel is incorporated in the display unit 12.

The computer main body 11 has a thin box-shaped case, and a keyboard 20 is provided in the center of the top surface of the case.

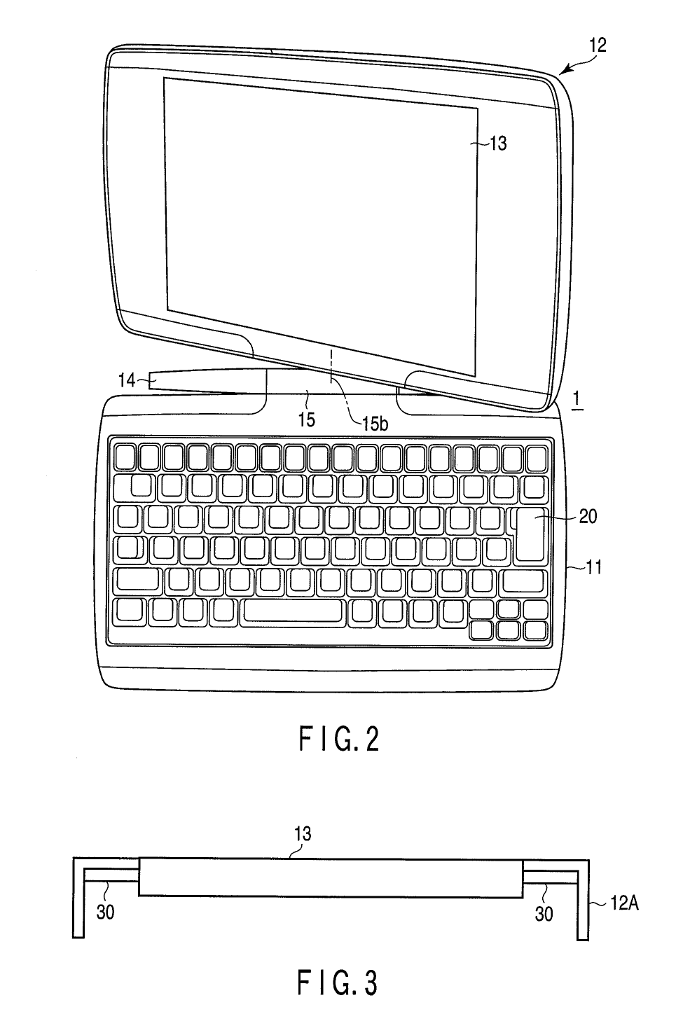

The display unit 12 is attached to a hinge 15 for rotating the display unit 12 around a shaft 15b, as shown in FIG. 2.

Furthermore, the hinge 15 is attached to a hinge (support portion) 14 which is used to rotate the display unit 12 around a shaft 15a and which is provided at a backside end of the computer main body 11, so that the display unit 12 may swingably change between a closed position at which it covers the top surface of the computer main body 11 and an open position at which the top surface of the computer main body 11 is exposed.

A plurality of touch switches 30a to 30B are arranged on the periphery of the LCD 13. The touch switches 30a to 30B are provided inside a case 12A of the display unit 12, as shown in FIG. 3.

The touch switches 30a to 30B are switches for inputting data into the computer main body 11 by detecting the change of capacitance. The touch switches 30a to 30B have capacitors. If, for example, a finger touches the surface of the touch switch, the capacitance of the capacitor changes, and a switch controller detects this change. The switch controller communicates to an embedded controller/keyboard controller IC that the capacitance of which touch switch has changed. Then, the present personal computer executes predetermined operation in accordance with the input data.

In addition, the plurality of touch switches do not necessarily have to be arranged on the periphery, and have only to be arranged in the vicinity of each sides adjacent to the LCD 13.

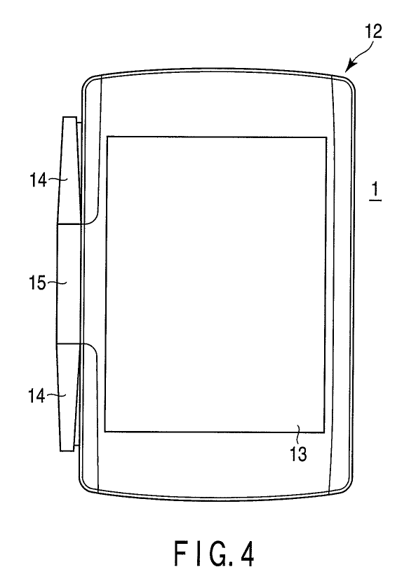

Furthermore, the display unit 12 is rotated 180 degrees by the hinges 14, 15 from the state shown in FIG. 1, and then the display unit 12 is swung to the closed position, such that a state shown in FIG. 4 can be produced. The keyboard 20 is not exposed in the state shown in FIG. 4. In addition, the present apparatus has sensors for detecting the direction of the main body, so that an image disposed on the LCD 13 can be normally viewed in response to the detected direction of the main body. Thus, this apparatus can also be handled in a horizontally long state tilted 90° from the vertically long state shown in FIG. 4.

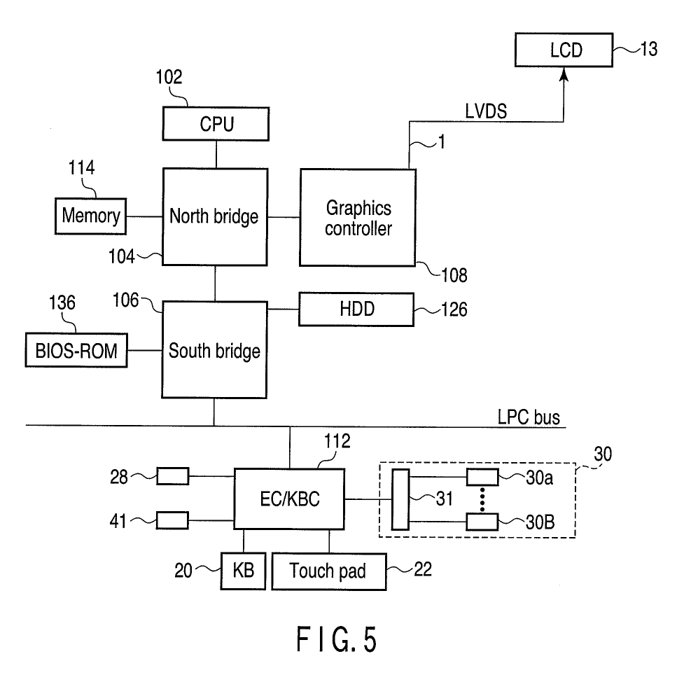

Next, a system configuration of the present computer is described with reference to FIG. 5.

As shown in FIG. 5, the present computer comprises a central processing unit (CPU) 102, a north bridge 104, a main memory 114, a graphics controller 108, a south bridge 106, a BIOS-ROM 136, a hard disk drive (HDD) 126 and an embedded controller/keyboard controller IC (EC/KBC) 112.

The CPU 102 is a processor provided to control the operation of the present computer, and executes an operating system (OS) and various application programs loaded from the hard disk drive (HDD) 126 into the main memory 114.

The CPU 102 also executes a system basic input/output system (BIOS) stored in the BIOS-ROM 136. The system BIOS is a program for controlling hardware.

The north bridge 104 is a bridge device for connection between a local bus of the CPU 102 and the south bridge 106. A memory controller for controlling the access to the main memory 114 is also incorporated in the north bridge 104. The north bridge 104 also has a function to communicate with the graphics controller 108 via an accelerated graphics port (AGP) bus.

The graphics controller 108 is a display controller for controlling the LCD 13 used as a display monitor of the present computer. This graphics controller 108 has a video memory (VRAM), and generates a video signal for forming a display image to be displayed on the LCD 13, from display data drawn in the video memory by the OS/application program. The video signal generated by the graphics controller 108 is output to a line 1.

When a switch controller 31 detects changes in the capacitances of the capacitors provided in the switches 30a to 30B, the switch controller 31 communicates to the embedded controller/keyboard controller IC (EC/KBC) 112 by a 16-bit serial signal that an event signal has been output from which switch. A bit of the 16-bit serial signal corresponding to the switch which has output the event signal goes high, such that it is possible to recognize which switch has output the event signal. In the case of the present apparatus, the signal from the switch controller 31 is input to the EC/KBC 112 which has a keyboard controller function. For example, a special input operation such as Ctrl+Alt+Del keys is allocated to the touch switch 30a at a particular position, so that when the particular switch is operated, a plurality of simultaneously input key codes such as the Ctrl+Alt+Del keys can be reported to the system.

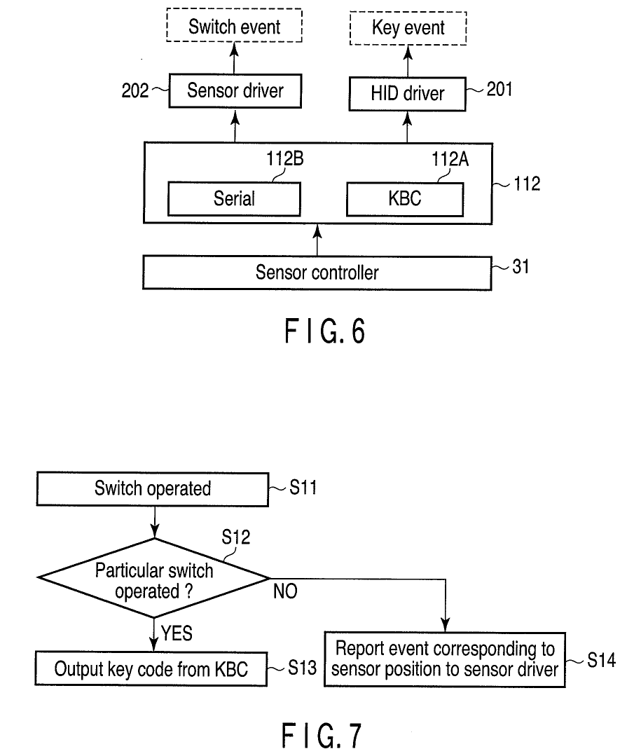

A configuration for reporting the input operation to the touch switches 30A to 30B to the system is shown in FIG. 6. As shown in FIG. 6, the signal from the switch controller 31 is input to a serial reception IC112B in the EC/KBC 112. When the operated touch switch is the particular switch to which the key input of a particular keyboard is allocated, the serial reception IC112B outputs a corresponding key code to a keyboard controller 112A. The keyboard controller 112A inputs a key event corresponding to the key code to the system via an HID driver 201. In addition, a single key can be allocated to a switch, and a key command corresponding to the allocated key can be reported to the system when the switch is operated.

When the operated touch switch is a switch to which the key input of the particular keyboard is not allocated, the even signal of the operated switch is reported to the system from the serial reception IC112B in the EC/KBC 112 via a sensor driver 202.

Furthermore, the procedure of processing concerning the touch switches in the EC/KBC 112 is shown in FIG. 7.

As shown in FIG. 7, when a switch is pressed (block S11), whether a particular place has been operated is determined (block S12). When it is determined that the particular place has been operated (YES in block S12), a key code corresponding to the system is reported to from the keyboard controller (KBC) 112A of the EC/KBC 112. When it is determined that the particular place has not been operated (NO in block S12), a serial reception IC switch driver is reported that a switch has been operated (block S14). In this regard, it is preferable to report information on the operated switch and operated time. The reason is that different operations can be allocated depending on the operation time of the switch.

Mounting the function as in the present embodiment enables the output of key codes, so that in contrast with products with no keyboards requiring keys for outputting Ctrl+Alt+Del, the particular switch in the present sensors enable such a function.

Some of the functions achieved by the information processing apparatus in which there are arranged a plurality of touch switches 30 mentioned above will be described in the following embodiments.

### SECOND EMBODIMENT

A function of improving the operability of zooming (enlarging/reducing) a screen is described in the present embodiment. It is to be noted that the LCD 13 is operated in a vertically long state in the case described in the present embodiment.

In addition, a resident enlarged display application hooks data for display sent from an operating system to the graphics controller 108, and the enlarged display application transmits enlarged displayed data which enlarges part of the data for display to a graphics controller 108 in accordance with the enlargement ratio, such that an enlarged display is performed. In addition, some of the graphics controllers 108 have enlarged display functions, so that in this case, the enlarged display is performed by transmitting a command to the graphics controller 108.

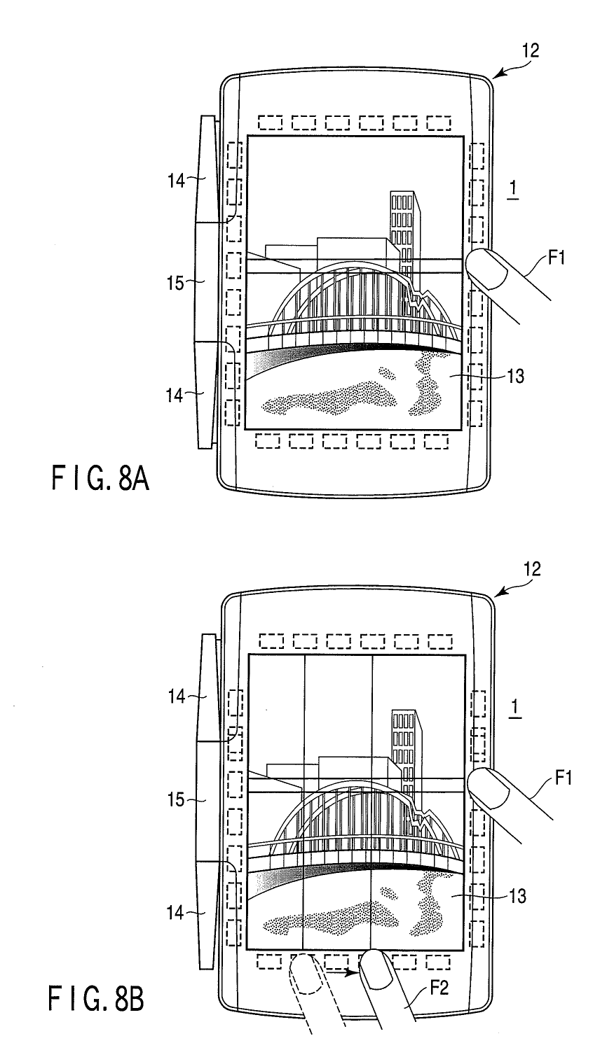

First, as shown in FIG. 8A, the case on a touch switch is touched by a first finger F1, and a position on a Y-axis (or X-axis) is determined.

Then, as shown in FIG. 8B, the case on touch switches is touched while the first finger F1 is in touch with the case, and a range to be zoomed on the X-axis (or Y-axis) is slid with a second finger F2, thereby determining a range.

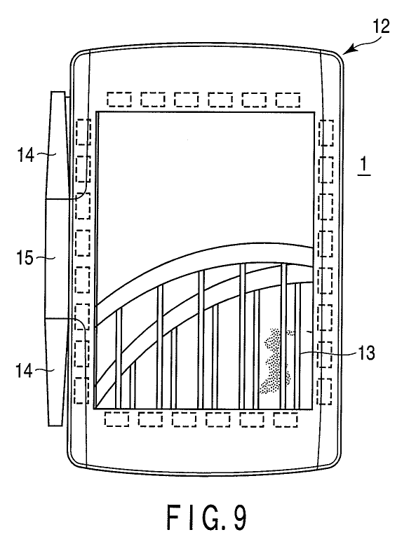

Consequently, as shown in FIG. 9, a range around the range determined in FIG. 8 is recognized as an area to be zoomed, and this area is zoomed at a screen ratio of the LCD 13.

For example, the case on touch switches is touched with the index finger when the Y-axis is first designated, and the case on touch switches is touched by the thumb in designating on the X-axis, such that the operation is facilitated.

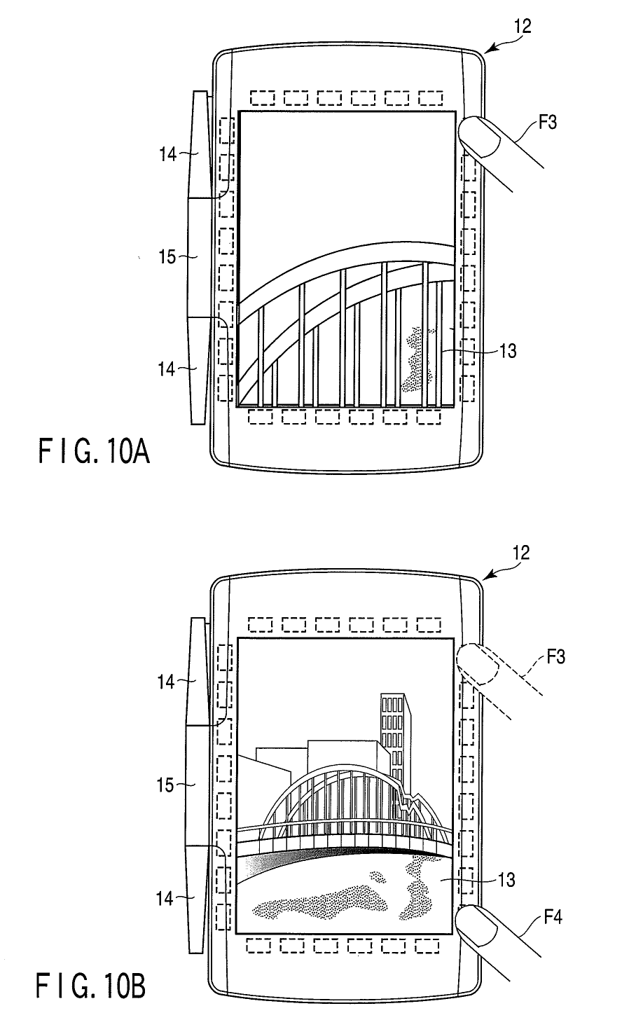

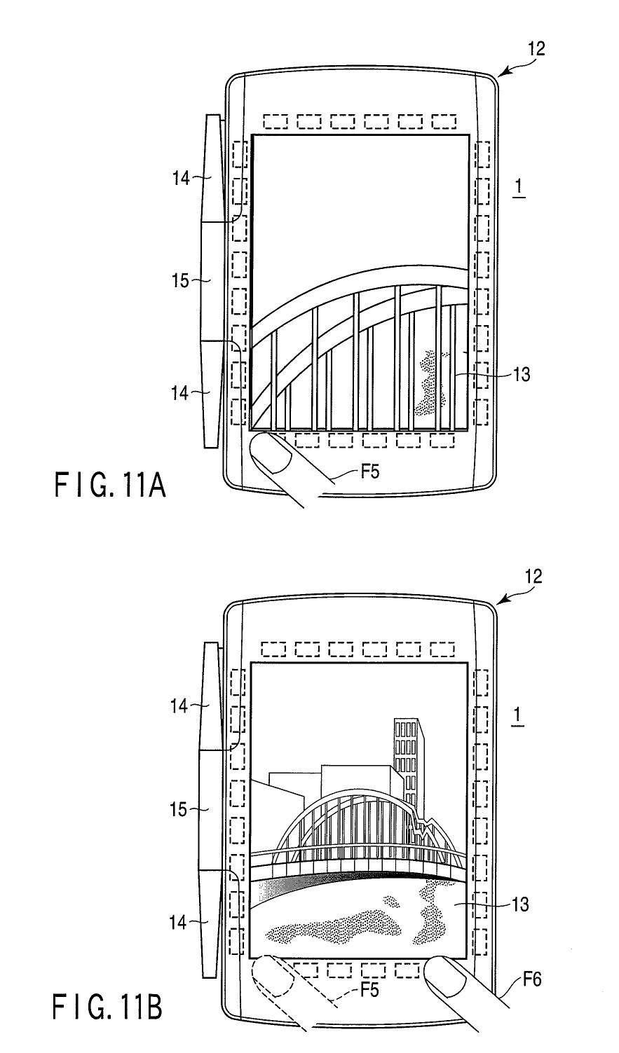

In addition, as shown in FIGS. 10A, 10B, 11A, and 11B, the zoom is cancelled or the screen returns to the original zoom state depending on the order in which the touch switches around the LCD are touched, which provides a user with easier zoom operation.

When the enlarged display is cancelled to changed to a normal display, the touch switch located on the upper right of the LCD 13 is operated with a finger F3 (FIG. 10A), and then the touch switch located on the lower right of the LCD 13 is operated with a finger F4 (FIG. 10B).

When the screen is returned from the normal display to the enlarged display, the touch switch 30 located on the lower right of the LCD 13 is operated with a finger F5 (FIG. 11A), and then the touch switch 30 located on the upper right of the LCD 13 is operated with a finger F6 (FIG. 11B).

When the sensors capable of recognizing a plurality of points are disposed around the LCD and operated with a plurality of fingers as in the present embodiment, the screen can be, for example, easily zoomed.

### THIRD EMBODIMENT

A function whereby a switch function by touching and a switch function by swiping (tracing operation) are doubly set in the same sensor region is described in the present embodiment.

As shown in FIG. 1, the electrostatic sensors are arranged around the screen, and eight sensors for the switches 30g to 30n are provided under the LCD 13.

When each of the switches 30g to 30n is touched, a function corresponding to each switch is called, thereby achieving the function as a switch.

Furthermore, a function can be allocated to the operation of tracing the switches 30g to 30n. For example, when the operation of tracing (swiping) the switch 30g to the switch 30n is performed, a function allocated to the swipe operation is called.

The swipe operation is distinguished from a button operation by the time of a sensor touch.

For example, when a touch on the switch 30g for 0.5 seconds or more is detected, the switch 30g works as a button 1. When a detection area is moving from 30g, 30h, . . . , to 30n within a time less than 0.5 seconds, this is detected as a swipe.

In the swipe operation, swipe operation patterns may be recognized so that a function is allocated to each pattern. For example, the following functions are allocated:

switch 30g→switch 30n: swipe 1

switch 30n→switch 30g: swipe 2

switch 30g→switch 30n→switch 30g: swipe 3.

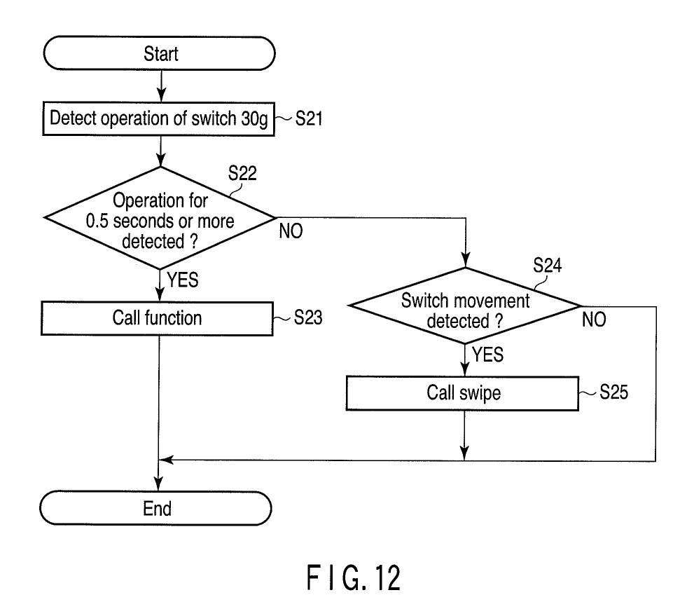

The procedure of processing for recognizing whether an operation provided to a particular switch is a button operation or a swipe operation is described with reference to FIG. 12. In addition, this processing is performed by the sensor driver 202.

When an operation on the switch 30g is detected (block S21), whether the time of the operation is 0.5 seconds or more is determined (block S22). When it is recognized that the time is 0.5 seconds or more (YES in block S22), the operation is recognized as a button operation, and a function allocated to the switch 30g is called (block S23). When it is determined that the time is not 0.5 seconds or more (NO in block S22), a determination is made on whether a movement to other switches including the switch 30g to which the swipe operation is allocated has been detected (block S24).

When it is determined that the movement has been detected (YES in block S24), the allocated swipe function is called (block S25). When it is determined that the movement has not been detected (NO in block S24), the processing is finished without calling the function.

According to the present function, it is possible to change the function to be called depending on the operation method, when the same area is operated. Consequently, the sensor area can be effectively used, and the sensor area necessary to achieve the equivalent switch can be reduced in size.

### FOURTH EMBODIMENT

In the present embodiment, an example is described in which different operations are allocated to the swipe function shown in the third embodiment depending on modes. It is to be noted that the LCD 13 is operated in a horizontally long state in the case described in the following embodiment.

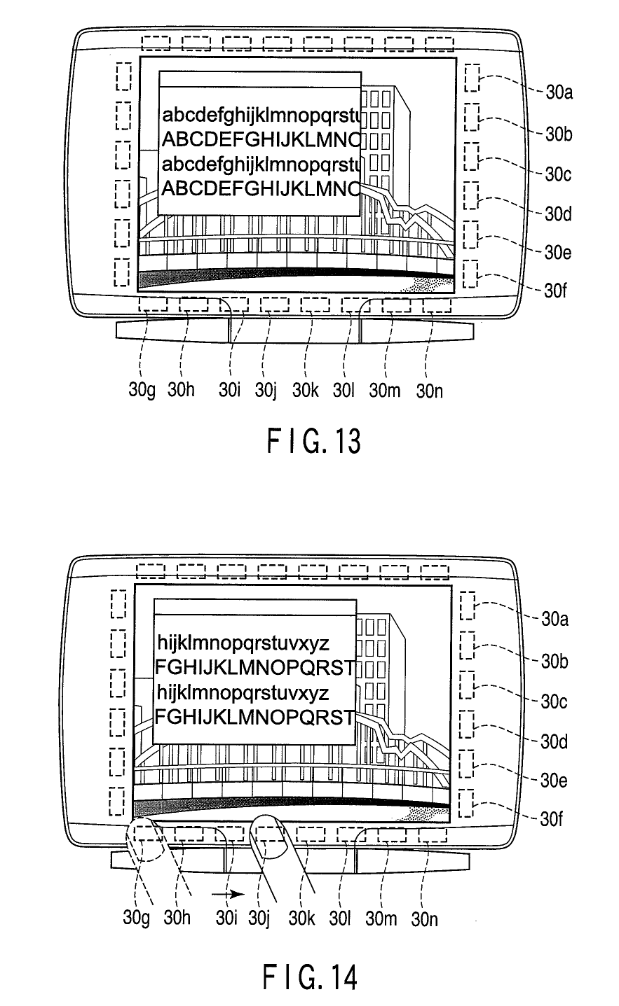

For example, a zoom display is performed as shown in FIG. 13 using the method described in the second embodiment. Then, the switches 30g to 30j are swiped. Thus, as shown in FIG. 14, contents displayed in the LCD 13 can be horizontally scrolled. In addition, the switches in the vertical direction can be operated in a tracing manner to vertically scroll the contents.

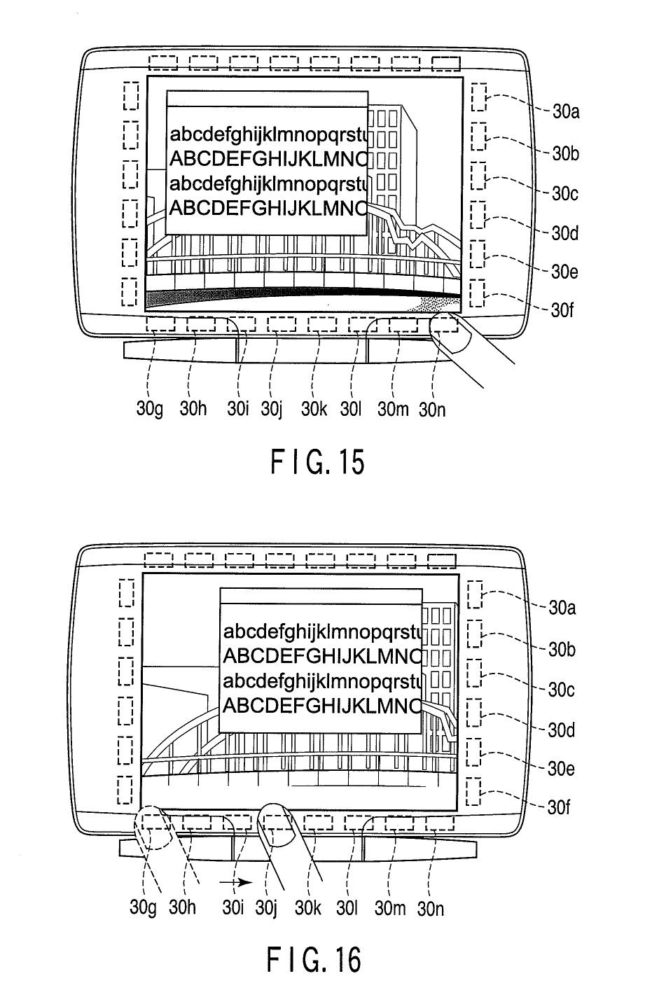

Furthermore, the switch 30f at the end is operated to switch to a zoom mode as shown in FIG. 15, and then the switches 30g to 30j are consecutively operated in a tracing manner as shown in FIG. 16, such that the enlarged screen can be horizontally scrolled. In addition, the switches in the vertical direction can be operated in a tracing manner to vertically scroll the enlarged screen.

It has been the case that either the scrolling of the contents or the movement of the enlarged screen can only be performed, and there are therefore problems of increased steps in the procedure of each operation and unclarity of the operations. According to the present function, the movement of the enlarged screen and the scrolling of the contents can be easily performed in an intuitively understandable manner during the enlarged display of the screen owing to the “tracing” operation.

### FIFTH EMBODIMENT

In a screen having a digitizer or a touch panel function, enlargement or reduction is performed around a position pointed with a pen or a finger in an enlargement or reduction mode. Described is a function of switching the mode to the enlargement or reduction mode using buttons on touch switches arranged on the periphery of a screen.

Sensors are disposed on the surface of an LCD of the present apparatus, and have the touch panel function.

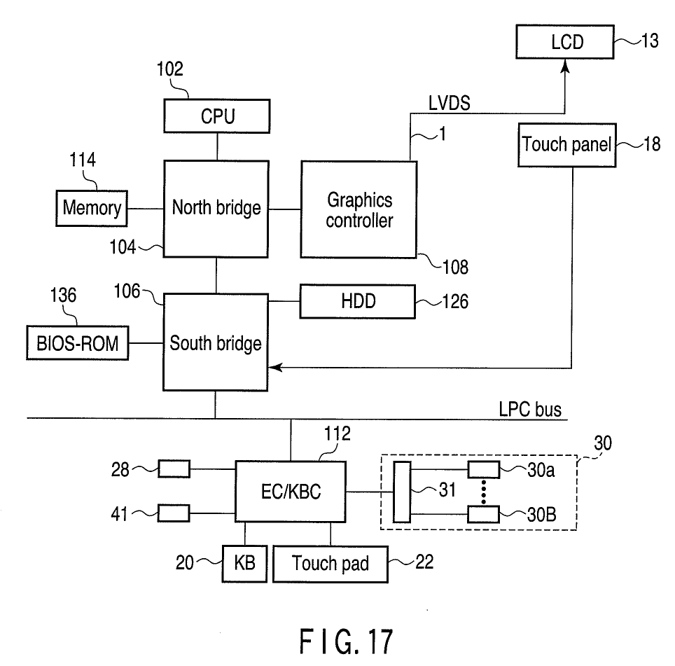

A system configuration of the information processing apparatus according to a fifth embodiment of the present invention is shown in FIG. 17.

As shown in FIG. 17, a signal from the sensor provided on the surface of the LCD is input to a USB controller embedded in a south bridge. The configuration of the present apparatus is similar to the configuration described with reference to FIG. 5 in other respects, and is therefore not described.

In the present apparatus, a user operates a particular switch, for example, a switch 30n such that a zoom mode is set. Then, the user touches an LCD 13 such that enlargement is performed around the touched position. When the user operates a particular sensor, the zoom mode is cancelled.

The procedure for zooming a particular area is described below.

Zoom In (Enlargement)

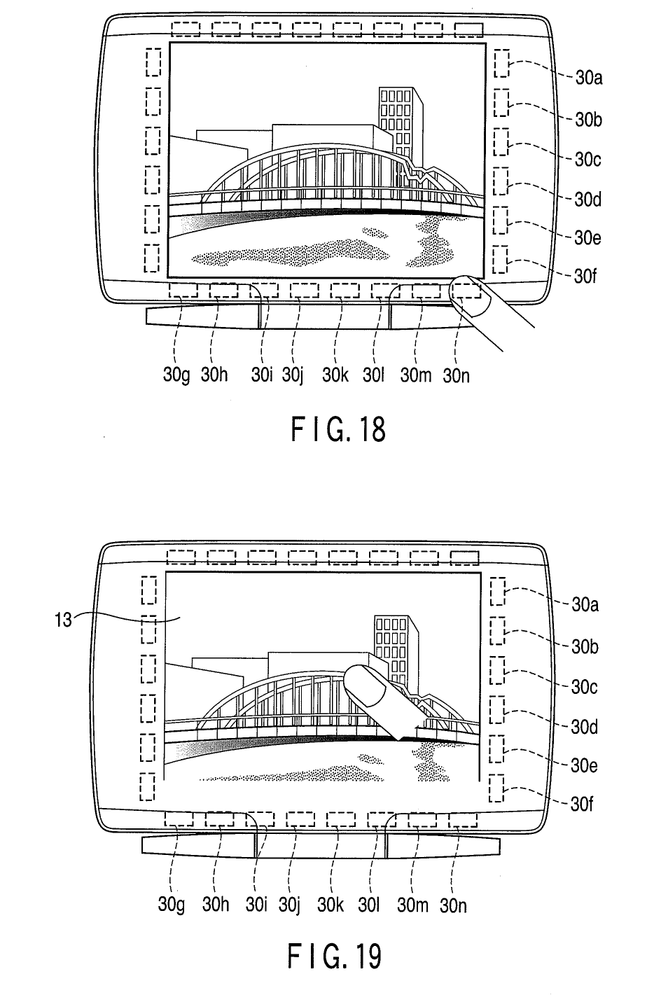

As shown in FIG. 18, a zoom mode switch 30n of the sensor is operated with a finger to set the zoom mode. In addition, it is preferable that the user is informed that the mode is the zoom mode, for example, by turning on an LED.

Then, as shown in FIG. 19, a place on the screen to be enlarged is pointed with a pen or a finger. Thus, a touch panel detects the pointed position and informs the system of the position.

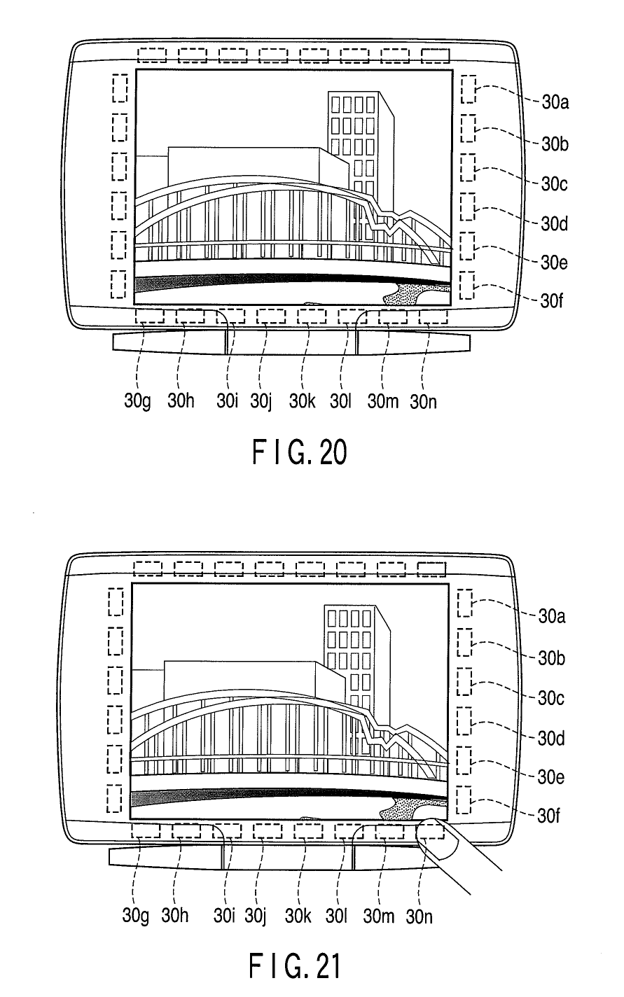

Consequently, as shown in FIG. 20, the screen is enlarged around the pointed place.

The cancellation of the zoom is described.

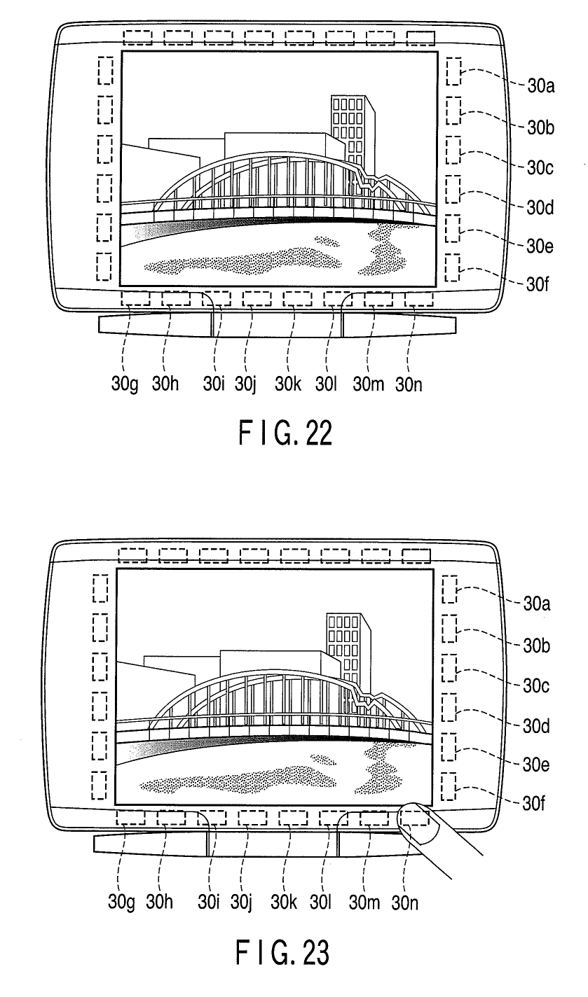

The zoom mode switch of the sensor is again operated with the finger as shown in FIG. 21, and the zoom mode is cancelled. Then, as shown in FIG. 22, the enlarged display is cancelled, and the screen shown in the LCD 13 returns to a normal display. In addition, it is preferable that the user is informed that the zoom mode has been cancelled, for example, by turning on an LED.

Moreover, the following modification of the present embodiment is conceived.

Two modes including a zoom mode (enlargement) and a zoom mode (reduction) are provided, and buttons into the respective modes are assigned. Enlargement is performed around the pointed position in the zoom mode (enlargement), and reduction is performed around the pointed position in the zoom mode (reduction). In addition, the display is not reduced to less than the normal display (one time).

The enlargement or reduction ratio is changed every time a position is pointed with a pen or a finger.

Instead of the LED, the user is informed of the zoom mode by an icon display of the zoom mode on the screen.

When the display is performed in the zoom mode, the ratio is displayed.

In order to simplify user operation, the ratio during enlargement is fixed.

According to the present embodiment, intuitive and quick operation can be performed in viewing the screen in terms of the following points:

A place to be enlarged can be designated by pointing. Moreover, having the zoom mode has the following advantages: The input of the digitizer or the touch panel can be used together with the normal pointing operation. Enlargement is achieved at the moment of a touch, such that the quick operation is enabled. The enlarged display can be continued even if the pen or the finger is taken off.

### SIXTH EMBODIMENT

A function of changing the enlargement ratio of the screen by sliding the touch switches with a finger is described in the present embodiment.

The procedure for zooming a particular area is described.

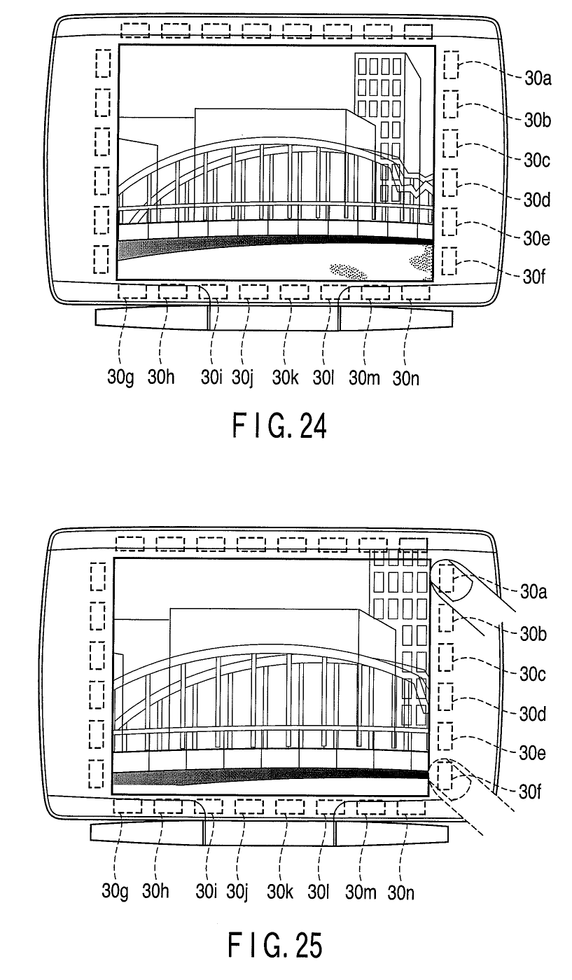

First, as shown in FIG. 23, the zoom mode switch 30n of the sensor is operated with a finger to set the zoom mode. As shown in FIG. 24, an enlarged screen is displayed. In addition, it is preferable that the user is informed that the mode is the zoom mode, for example, by turning on an LED.

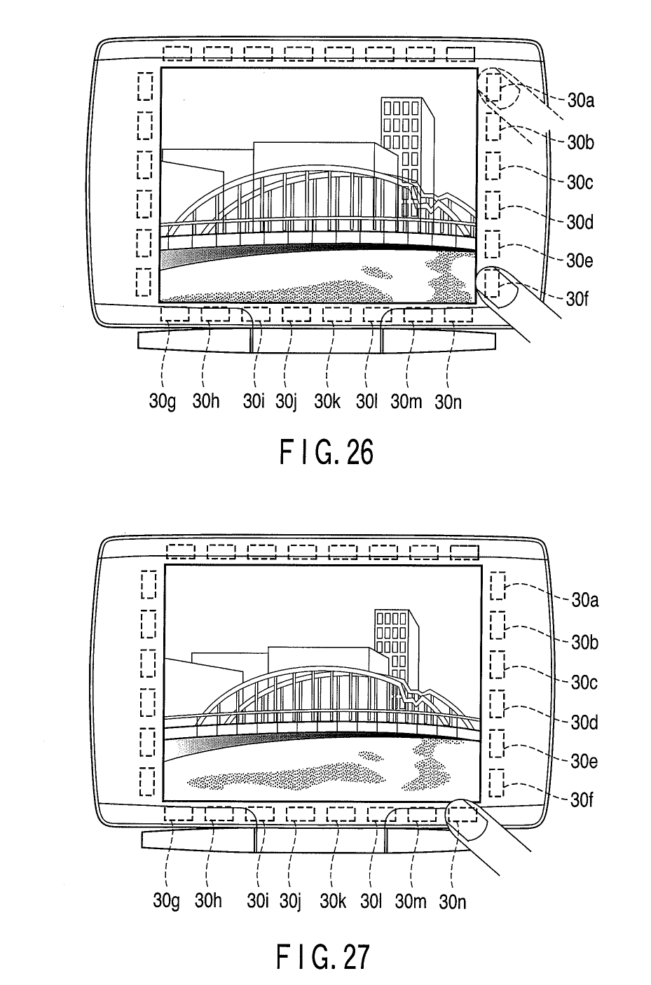

Then, the arrangement area of the switches 30a to 30f in the vicinity of the right side of the LCD 13 is slid with a finger such that a size to be zoomed is freely set. At this point, as shown in FIG. 25, the switches 30a to 30f can be operated from the lower side to the upper side to gradually increase the enlargement ratio. Moreover, as shown in FIG. 26, the switches 30a to 30f can be operated from the upper side to the lower side to gradually decrease the enlargement ratio.

The cancellation of the zoom is described.

As shown in FIG. 27, the zoom mode switch 30n of the sensor is again operated with the finger, and the zoom mode is cancelled. In addition, it is preferable that the user is informed that the zoom mode has been cancelled, for example, by turning on an LED. Then, the screen returns to the normal display.

According to the present embodiment, enlargement and reduction operations can be performed by intuitive operation. Moreover, operation is performed around the screen, so that enlargement and reduction operations can be enabled without impairing the display area due to control. Further, a plurality of sensors that are arranged can be used as a slider to perform consecutive enlargement or reduction operations.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a case;
a display in the case;
a plurality of touch switches arranged inside the case and configured to output a signal in accordance with a change of capacitance, two or more of the plurality of touch switches being arranged along two adjacent sides of the display;
a keyboard controller configured to receive a key code; and
a touch switch controller configured to receive the signal of the plurality of touch switches, further configured to output to the keyboard controller the key code which corresponds to substantially simultaneous inputs of a plurality of keys associated to an operation of a first touch switch, when the signal is entered from the first touch switch.

2. The information processing apparatus of claim 1, wherein the touch switch controller is configured not to output the key code corresponding to the substantially simultaneous input operations of the plurality of corresponding keys when the plurality of touch switches comprising the first touch switch are operated consecutively.

3. The information processing apparatus of claim 2, wherein the touch switch controller is configured to output an event signal when the plurality of touch switches comprising the particular touch switch are consecutively operated.

4. An information processing apparatus comprising:
a case;
a display in the case;
a plurality of touch switches arranged inside the case and configured to output an operation signal in accordance with a change of capacitance, two or more touch switches being arranged along two adjacent sides of the display;
an enlargement module configured to enlarge an image displayed on the display when a first touch switch is operated; and
a ratio changing module configured to change an enlargement ratio by consecutively operating the plurality of touch switches arranged in one direction among the touch switches after the image is enlarged.

5. The information processing apparatus of claim 4, wherein the enlargement module is configured to change a region displayed on the display by consecutively operating a plurality of touch switches arranged in one direction among the touch switches when the image displayed on the display device is enlarged.

6. An information processing apparatus comprising:
a case;
a display in the case;
a plurality of touch switches arranged inside the case and configured to output an operation signal in accordance with a change of capacitance, two or more touch switches being arranged along two adjacent sides of the display;
an enlargement module configured to enlarge an image region in an image on the display corresponding to two operated positions by continuously operating one or more of the touch switches arranged in a first direction while operating one of the touch switches arranged in a second direction perpendicular to the first direction among the plurality of touch switches.

7. The information processing apparatus of claim 5, wherein the enlargement module is configured to change a region displayed on the display by consecutively operating a plurality of touch switches arranged in one direction among the touch switches when the image displayed on the display is enlarged.
